(19) United States
(12) Patent Application Publication
(10) Pub. No.: US 2018/0129914 A1
(43) Pub. Date: May 10, 2018

(54) IMAGE RECOGNITION DEVICE AND IMAGE RECOGNITION METHOD

(71) Applicant: OLYMPUS CORPORATION, Tokyo (JP)

(72) Inventors: Mitsutomo Kariya, Tokyo (JP); Akira Ueno, Tokyo (JP)

(73) Assignee: OLYMPUS CORPORATION, Tokyo (JP)

(21) Appl. No.: 15/846,618

(22) Filed: Dec. 19, 2017

Related U.S. Application Data
(63) Continuation of application No. PCT/JP2016/062357, filed on Apr. 19, 2016.

(30) Foreign Application Priority Data
Jun. 22, 2015 (JP) 2015-124786

(51) Int. Cl. G06K 9/62

(52) U.S. Cl. CPC G06K 9/6269; G06K 9/6256; G06K 9/6212

(57) ABSTRACT

An image recognition device includes SVM operator which performs SVM operation on input image and data storage which temporarily stores data generated during image recognition process, wherein the SVM operator includes feature value calculator which calculates feature value representing degree to which recognition target that is target captured in the input image is similar to comparison target to be recognized, and cumulative adder which cumulatively adds feature values corresponding to teacher data classified into the same type of comparison targets in teacher data group. In the SVM operation process, the feature value calculator calculates feature values corresponding to all teacher data and stores the feature values in the data storage, and the cumulative adder cumulatively adds feature values of the same type of comparison targets and outputs the feature values as recognition result of the recognition target in the image recognition process.

### CROSS REFERENCE TO RELATED APPLICATIONS

This application is a continuation application based on a PCT Patent Application No. PCT/JP2016/062357, filed on Apr. 19, 2016, whose priority is claimed on Japanese Patent Application No. 2015-124786, filed Jun. 22, 2015, the entire contents of which are hereby incorporated by reference.

### BACKGROUND OF THE INVENTION

### Field of the Invention

The present invention relates to an image recognition device and an image recognition method.

### Description of the Related Art

A convention image recognition technology recognizes an object in a captured image, that is, a subject (target) and a scene in which an image has been captured (refer to Non Patent Literature 1: Keiji YANAI, “Category recognition according to Bag-of-Keypoints,” 14^{th} Image Sensing Symposium (SSII2008), Jun. 13, 2008). In the conventional image recognition technology, a scene in which an image has been captured is recognized through the following processing procedures.

(Procedure 1): A set of representative local patterns (visual words) in an input image is generated.

(Procedure 2): Histograms (recognition object data) of the entire input image are generated based on the visual words.

(Procedure 3): Recognition object data is compared with each piece of large amount of teacher data to recognize a scene of the input image.

Teacher data refers to a histogram obtained by classifying and arranging a large amount of images into target types. In the conventional image recognition technology, for example, a support vector machine (SVM) operation or the like is performed in the process of the aforementioned Procedure 3 to calculate a feature value indicating a degree to which a target captured in an input image is similar to a target represented by each piece of teacher data for each piece of the teacher data. Then, a target represented by teacher data having the largest feature value is recognized as the target captured in the input image or a scene of a captured target having the largest feature value.

In the SVM operation, a feature value for each piece of teacher data is calculated through the following procedures.

(Procedure 3-1): One piece of teacher data is read from a large amount of teacher data.

(Procedure 3-2): The read teacher data is compared with recognition object data to calculate a feature value (Kernel).

(Procedure 3-3): The calculated feature values are cumulatively added.

(Procedure 3-4): The cumulatively added feature value is output as a similarity representing a degree to which a target captured in an input image is similar to a target represented by each piece of teacher data.

Further, in the conventional image recognition technology, for example, 1500 pieces of teacher data classified into targets of the same type are read from 5000 pieces of teacher data, and 1500 feature values are cumulatively added and output as similarities in order to output a similarity for one target. That is, in the conventional image recognition technology, processing procedures of the aforementioned Procedures 3-1 to 3-3 are repeated 1500 times to output a similarity for one target included in an input image for each targets classified in the teacher data.

In the conventional image recognition technology, as many similarities as the number of targets of recognition objects included in the input image, that is, the number of scenes are output. That is, in the conventional image recognition technology, processing procedures of the aforementioned Procedures 3-1 to 3-4 are repeated for each scene to output a similarity for each recognition object targets.

### SUMMARY

According to a first aspect of the present invention, an image recognition device which performs an image recognition process on an input image based on a teacher data group including a plurality of pieces of teacher data corresponding to histograms of images of comparison targets to be recognized and classified into each type of the comparison targets includes: a support vector machine (SVM) operator which performs an SVM operation on histograms generated based on the visual words of the images, based on each of the plurality of pieces of teacher data included in the teacher data group; and a data storage which temporarily stores data generated during the image recognition process, wherein the SVM operator includes: a feature value calculator which compares histograms of the input images with histograms of the comparison targets represented by the teacher data and calculates feature values representing degrees to which a recognition target that is a target captured in the input image is similar to the comparison targets; and a cumulative adder which cumulatively adds the feature values corresponding to the teacher data classified into the same type of comparison targets, and in the SVM operation process, the feature value calculator calculates all feature values corresponding to all teacher data included in the teacher data group for each piece of teacher data and stores all of the calculated feature values in the data storage, and the cumulative adder reads the feature value corresponding to the teacher data classified into the same type of comparison targets from all of the store feature values, cumulatively adds the read feature values and outputs the cumulatively added feature values as a recognition result of the recognition target in the image recognition process, after the feature value calculator stores all of the feature values in the data storage.

According to a second aspect of the present invention, in the image recognition device of the first aspect, the feature value calculator may calculate all feature values corresponding to all teacher data included in the teacher data group and stores the feature values in the data storage when the number of pieces of teacher data included in the teacher data group is less than the number of times the cumulative adder reads and cumulatively adds the feature values stored in the data storage until all recognition results of the recognition target are output in the image recognition process.

According to a third aspect of the present invention, in the image recognition device of the second aspect, the image recognition device may further include a teacher data decompressor which decompresses the teacher data group input in a format in which all teacher data has been integrated into one piece of data and reversibly compressed to restore respective pieces of teacher data, wherein, in the SVM operation process, the teacher data decompressor decompresses the teacher data group to restore the respective pieces of teacher data, and the feature value calculator calculates all feature values corresponding to respective pieces of teacher data restored by the teacher data decompressor and stores the feature values in the data storage.

According to a fourth aspect of the present invention, in the image recognition device of the second or third aspect, the image recognition device may further include:
an arbitration part which arbitrates use of the data storage by a visual word operator which exclusively performs operation processes in the image recognition process, a histogram operator, and the SVM operator, wherein the arbitration part accesses the data storage in response to access to the data storage by any one operator to which use of the data storage is allocated.

According to a fifth aspect of the present invention, the image recognition device of the fourth aspect, the data storage may have a storage capacity which can save a maximum amount of data to be temporarily stored in the data storage when the visual word operator, the histogram operator and the SVM operator execute processes thereof.

According to a sixth aspect of the present invention, an image recognition method in an image recognition device which performs an image recognition process on an input image based on a teacher data group including a plurality of pieces of teacher data corresponding to histograms of images of comparison targets to be recognized and classified into each type of the comparison targets includes: a support vector machine (SVM) operation step of performing an SVM operation on histograms generated based on the visual words of the images based on each of the plurality of pieces of teacher data included in the teacher data group, wherein the SVM operation step includes: a feature value calculation step of comparing histograms of the input images with histograms of the comparison targets represented by the teacher data and calculating feature values representing degrees to which a recognition target that is a target captured in the input image is similar to the comparison targets, and a cumulative addition step of cumulatively adding the feature values corresponding to the teacher data classified into the same type of comparison targets, and in the feature value calculation step, the feature values corresponding to all teacher data included in the teacher data group are calculated for each piece of teacher data and all of the calculated feature values are stored in a data storage which temporarily stores data generated during the image recognition process, and in the cumulative addition step, the feature values corresponding to the teacher data classified into the same type of comparison targets are read from all of the stored feature values and cumulatively added, and the cumulatively added feature values are output as a recognition result of the recognition target in the image recognition process, after all of the feature values are stored in the data storage in the feature value calculation step.

### BRIEF DESCRIPTION OF THE DRAWINGS

FIG. 1 is a block diagram illustrating a schematic configuration of an image recognition device in a first embodiment of the present invention.

FIG. 2 is a diagram illustrating a data flow when an image recognition process is performed in the image recognition device of the first embodiment of the present invention.

FIG. 3 is a flowchart illustrating a processing procedure in the intake recognition process in the image recognition device of the first embodiment of the present invention.

FIG. 4 is a block diagram illustrating a schematic configuration of an image recognition device in a second embodiment of the present invention.

FIG. 5 is a diagram illustrating a data flow when an image recognition process is performed in the image recognition device of the second embodiment of the present invention.

FIG. 6 is a block diagram illustrating a schematic configuration of an image recognition device in a third embodiment of the present invention.

FIG. 7 is a diagram illustrating a data flow when an image recognition process is performed in the image recognition device of the third embodiment of the present invention.

### DETAILED DESCRIPTION OF THE PREFERRED EMBODIMENTS

### First Embodiment

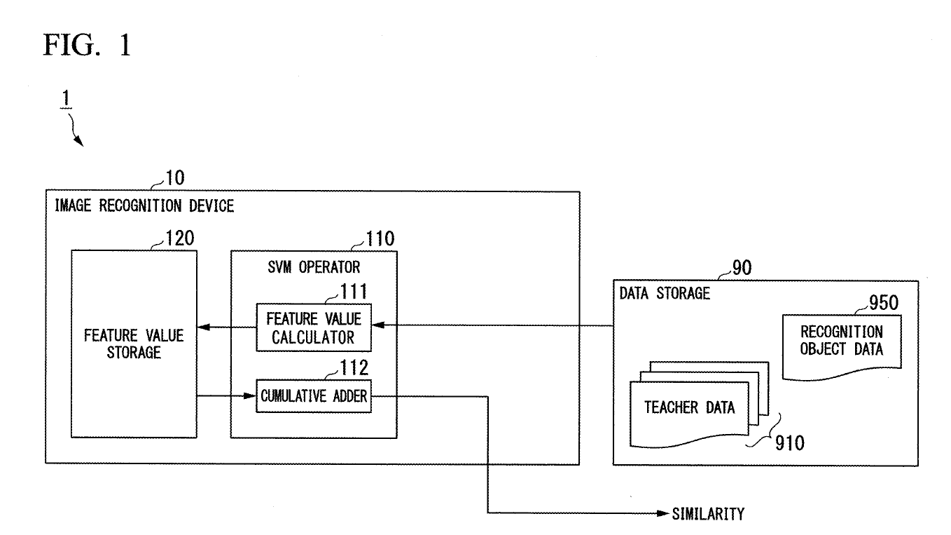

Hereinafter, embodiments of the present invention will be described with references to the drawings. FIG. 1 is a block diagram illustrating a schematic configuration of an image recognition device in a first embodiment of the present invention. In FIG. 1, an image recognition device 10 includes a support vector machine (SVM) operator 110 and a feature value storage 120. The SVM operator 110 includes a feature value calculator 111 and a cumulative adder 112. FIG. 1 also illustrates a data storage 90 which stores data used when the image recognition device 10 performs an image recognition process and shows an image recognition system 1 including the image recognition device 10.

The image recognition device 10 performs an image recognition process for recognizing an object captured in an image, that is, a subject (target) and scene of a captured image, for an input image and outputs information on a similarity with each piece of teacher data classified into types (categories) of various targets as information indicating a degree to which the subject (target) recognized through the image recognition process is similar to a classified target. The image recognition device 10 also performs the same processes as the conventional image recognition technology, such a visual word operation process for generating a set of representative focal patterns (visual words) in an input image, and an operation process for generating histograms of the entire input image based on visual words in the image recognition process. The following description will be based on the assumption that the visual word operation process and the histogram operation process for the input image are completed.

The data storage 90 stores a teacher data group 910 used when the image recognition device 10 performs the image recognition process and recognition object data 950 as histograms of an image of an object for which the image recognition device 10 performs the image recognition process. For example, the data storage 90 is a memory such as a dynamic random access memory (DRAM). The data storage 90 outputs the stored teacher data group 910 and recognition object data to the image recognition device 10 in response to data read control of the image recognition device 10. A method of storing each piece of data in the data storage 90, that is, data write control, is not particularly limited in the present invention.

The teacher data group 910 includes histograms of a large amount of images having an identical target (referred to as a “comparison target” hereinafter) captured therein as teacher data classified into each comparison target type recognized in the image recognition device 10. However, each histogram is not exclusive for each comparison target type and the same histograms may correspond to (may be duplicate for) different comparison target types. That is, one piece of teacher data may be classified into a plurality of comparison target types. Accordingly, the number of pieces of teacher data included in the teacher data group 910 is less than the total number of histograms corresponding to respective comparison target types.

For example, when the teacher data group 910 includes teacher data of four types of comparison targets, a person, a dog, a cat and a flower, a predetermined number, for example, 1500 histograms, are included in each comparison target type. That is, the teacher data group includes 1500 histograms for one comparison target which is “person” and also includes 1500 histograms for each of comparison targets which are “dog,” “cat” and “flower” in the same manner. That is, the teacher data group 910 includes a predetermined number of histograms corresponding to each of the four types of comparison targets (a total of 4×1500=6000 histograms). However, histograms classified into each comparison target included in the teacher data group 910 include histograms which are duplicate in a plurality of comparison targets and thus are composed of 5000 pieces of teacher data, for example.

Although the teacher data group 910 includes 1500 histograms classified into each of four types of comparison targets (a total of 6000 histograms), the number of pieces of teacher data constituting the teacher data group 910 is 5000 in the following description. That is, in the following description, 1000 histograms correspond to (are duplicate for) a plurality of comparison target types in the 6000 histograms indicated by the teacher data group 910.

For example, the recognition object data 950 is data of histograms of an entire image, which represents a target (referred to as a “recognition target” hereinafter) of a recognition object captured in an image photographed by a photographing system equipped with the image recognition system 1 or a scene in which the image has been captured. That is, the recognition object data 950 is data which represents, as histograms, features of a recognition target on which the image recognition process is performed in the image recognition device 10. For example, the recognition object data 950 is generated through a visual word operation process and a histogram operation process in the image recognition device 10.

The image recognition device 10 performs the image recognition process on the recognition object data 950 stored an the data storage 90 based on each piece of teacher data included in the teacher data group 910 stored in the data storage 90 and outputs information on a similarity with each piece of teacher data for each piece of teacher data.

The SVM operator 110 performs an SVM operation of comparing histograms of an entire image represented by the recognition object data 950 with histograms of a comparison target represented by each piece of teacher data included in the teacher data group 910 and calculates a similarity for each comparison target type classified in the teacher data group 910 in the image recognition process. The SVM operator 110 outputs information representing the similarity for each comparison target type, which is calculated through the SVM operation, as information on the recognition target recognized through the image recognition process performed by the image recognition device 10 when calculation of similarities too all piece of recognition object data 950 is completed, that is, the SVM operation is completed.

The feature value calculator 111 compares a histogram represented by each piece of teacher data read from the data storage 90 with the histograms represented by the recognition object data 950 and calculates a feature value (Kernel) which represents a degree to which a recognition target included in the recognition object data 950 is similar to a comparison target represented by teacher data, for each piece of teacher data. The feature value calculator 111 outputs each feature calculated for each piece of teacher data to the feature value storage 120. The feature value calculator 111 compares each histogram represented by the teacher data included in the teacher data group 910 with the histograms represented by the recognition object data 950 to calculate feature values corresponding to all pieces of teacher data and outputs all the calculated feature values to the feature value storage 120. That is, the feature value calculator 111 calculates 5000 feature values corresponding to 5000 pieces of teacher data included in the teacher data group 910 and outputs the feature values to the feature value storage 120. A feature value calculation method in the feature value calculator 111 is the same as the feature value calculation method in the conventional image recognition technology and thus detailed description thereof is omitted.

The cumulative adder 112 reads feature vales corresponding to teacher data classified into the same type of comparison targets from feature values for the teacher data, which are stored in the feature value storage 120, and cumulatively adds the read feature values. That is, the cumulative adder 112 reads 1500 feature values, which have been classified into the same comparison target type, from feature values corresponding to all teacher data and stored in the feature value storage 120 and cumulatively adds the read feature values. In addition, the cumulative adder 112 outputs the cumulatively added feature values as information on similarities between classified comparison targets and the recognition target included in the recognition object data 950. That is, the cumulative adder 112 outputs the cumulatively added feature values as a result of the image recognition process. A method of cumulatively adding feature values in the cumulative adder 112 is the same as the method of cumulatively adding feature values in the conventional image recognition technology and thus detailed description thereof is omitted.

The feature value storage 120 temporarily stores a feature value for each piece of teacher data, which is calculated by the feature value calculator 111 in the SVM operator 110. For example, the feature value storage 120 is a memory such as a static random access memory (SRAM). The feature value storage 120 stores each of the 5000 feature values output from the feature value calculator 111 according to data write control of the feature value calculator 111. In addition, the feature value storage 120 outputs 1500 feature values stored therein to the cumulative adder 112 according to data read control of the cumulative adder 112 in the SVM operator 110.

In this manner, the image recognition device 10 included the feature value storage 120 which stores the feature value corresponding to each piece of teacher data. In addition, the image recognition device 10 calculates feature values corresponding to all the teacher data included in the teacher data group 910 and stores the feature values in the feature value storage 120, and then reads feature values corresponding to teacher data classified into the same comparison target type from the feature values stored in the feature value storage 120, cumulatively adds the read feature values and outputs the cumulatively added feature values as information representing a similarity for each comparison target type (result of the image recognition process) in the SVM operation in the image recognition process.

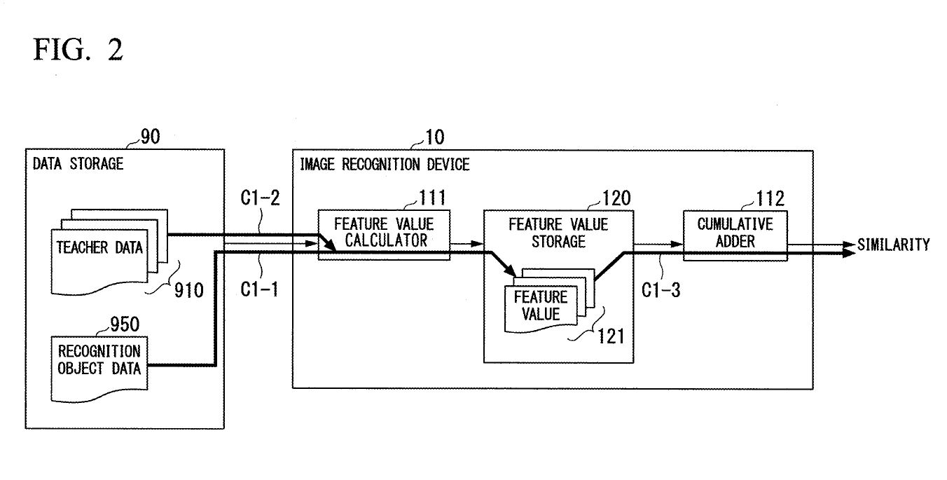

Data flow when the image recognition device 10 performs the image recognition process will be described. FIG. 2 is a diagram illustrating data flow when the image recognition process is performed in the image recognition device 10 of the first embodiment of the present invention. FIG. 2 shows data flow of the SVM operation process in the image recognition process performed by the image recognition device 10. That is, the data flow shown in FIG. 2 is data flow when the image recognition device 10 performs the SVM operation process after completion of the visual word operation process and histogram operation process for an image input to the image recognition device 10.

In the SVM operation process in the image recognition device 10, the feature value calculator 111 included in the SVM operator 110 reads the recognition object data 950 from the data storage 90 (path C1-1). Further, the feature value calculator 111 sequentially reads all teaches data included in the teacher data group 910 from the data storage 90 (path C1-2). In addition, the feature value calculator 111 calculates feature values based on each of the read recognition object data and the teacher data and temporarily stores the calculated feature values in the feature value storage 120. FIG. 2 illustrates a state in which feature values 121 calculated by the feature value calculator 111 have been stored in the feature value storage 120.

Subsequently, in the SVM operation process in the image recognition device 10, the cumulative adder 112 included in the SVM operator 110 reads feature values 121 corresponding to teacher data classified into the same comparison target type from the feature values 121 stored in the feature value storage 120 by the feature value calculator 111, cumulatively adds the read feature values 121 and outputs the cumulatively added feature values as information representing similarities with comparison targets represented by the read feature values 121 (result of the image recognition process) (path C1-3).

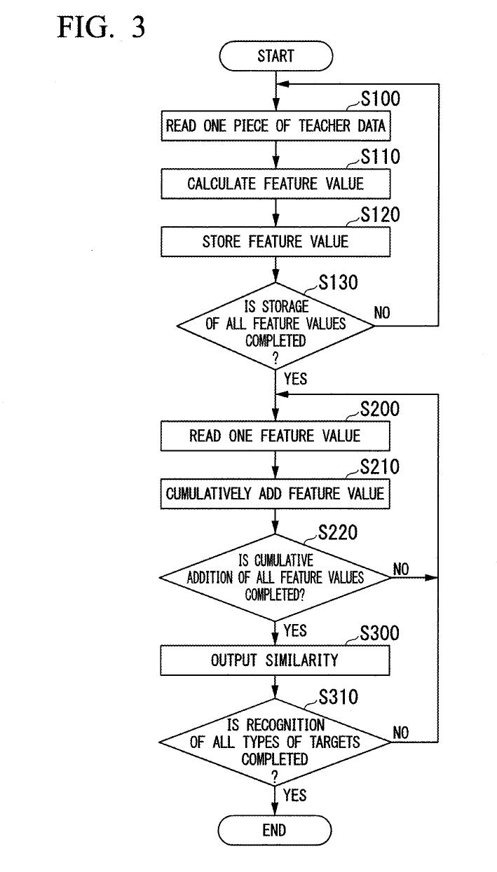

Next, the operation when the image recognition device 10 performs the image recognition process will be described. FIG. 3 is a flow/chart illustrating a processing procedure of the image recognition process in the image recognition device 10 of the first embodiment of the present invention. Further, FIG. 3 shows a processing procedure of the SVM operation process in the image recognition process performed by the image recognition device 10. That is, the processing procedure shown in FIG. 3 is a processing procedure when the intake recognition device 10 performs the SVM operation process after completion of the visual word operation process and the histogram operation process for an image input to the image recognition device 10.

In the following description, 1500 histograms corresponding to each of four types of comparison targets (a total of 6000 histograms) are included in the teacher data group 910 and the teacher data group 910 is composed of 5000 pieces of teacher data (1000 histograms are duplicate).

When the image recognition device 10 (SVM operator 110) initiates the SVM operation process, first, the feature value calculator 111 included in the SVM operator 110 reads the recognition object data 950 from the data storage 90 (refer to path C1-1 of FIG. 1).

Then, the image recognition device 10 (SVM operator 110) performs the SVM operation for each piece of teacher data from step S100. In the SVM operations, first, the feature value calculator 111 reads one piece of teacher data (first teacher data) included in the teacher data group 910 stored in the data storage 90 in step S100 (refer to path C1-2 of FIG. 2).

Subsequently, the feature value calculator 111 compares a histogram represented by the read first teacher data with histograms represented by the recognition object data 950 to calculate a feature value in step S110. Then, the feature value calculator 111 outputs the calculated feature value corresponding to the first teacher data to the feature value storage 120 and stores the feature value in the feature value storage 120 in step S120. Accordingly, the feature value 121 corresponding to the first teacher data illustrated in FIG. 2 is stored in the feature value storage 120.

Subsequently, the feature value calculator 111 determines whether feature values corresponding to all teacher data included in the teacher data group 910 stored in the data storage 90 have been stored in the feature value storage 120, that is, whether reading of all teacher data and calculation of feature values are completed in step S130.

When it is determined that the feature values corresponding to all the teacher data, that is, all feature values have not been stored in the feature value storage 120 in step S310 (“NO” in step S310), the feature value calculator 111 returns to step S100 and reads the next one piece of teacher data (second teacher data) included in the teacher data group 910 (refer to path C1-2 of FIG. 2). Then, the feature value calculator 111 repeats the process of steps S110 to S130 until storage of all feature values in the feature value storage 120 is completed. Since the teacher data group 910 is composed of 5000 pieces of teacher data, the feature value calculator 111 repeats the process of steps S100 to S130 5000 times.

When it is determined that all feature values have been stored in the feature value storage 120 in step S130 (“YES” in step S130), the feature value calculator 111 proceeds to step S200.

Subsequently, the cumulative adder 112 included in the SVM operator 110 reads one feature value (first feature value) corresponding to teacher data classified into the same comparison target type and stored in the feature value storage 120 in step S200 (refer to path C1-3 of FIG. 2).

Subsequently, the cumulative adder 112 cumulatively adds the read first feature value in step S210. Then, the cumulative adder 112 determines whether cumulative addition of all feature values corresponding to the teacher data classified into the same comparison target type and stored in the feature value storage 120 is completed, that is, whether reading of all feature values of the same comparison target type and cumulative addition of the feature values are completed, in step S220.

When it is determined that cumulative addition of all feature values corresponding to the teacher data classified into the same comparison target type is not completed, that is, a final result of similarities with the comparison targets, which is presently output, is not acquired in step S220 (“NO” in step S220), the cumulative adder 112 returns to step S200 and reads the next one feature value (second feature value) corresponding to the teacher data classified into the same comparison target type and stored in the feature value storage 120 (refer to path C1-3 of FIG. 2). Then, the cumulative adder 112 repeats the process of steps S210 and S220 until cumulative addition of all feature values is completed. Since the teacher data group 910 includes 1500 histograms corresponding to one comparison target type, the cumulative adder 112 repeats the process of steps S200 to S220 1500 times.

When it is determined that cumulative addition of al feature values corresponding to the teacher data classified into the same comparison target type is completed, that is, the final result of similarities with the comparison targets, which is presently output, is acquired in step S220 (“YES” in step S220), the cumulative adder 112 proceeds to step S300.

Subsequently, the cumulative adder 112 outputs the cumulatively added feature value acquired through the process of steps S200 to S220, that is, information on similarities between presently output comparison targets classified into the same type and the recognition target included in the recognition object data (result of the image recognition process) in step S300.

Then, the cumulative adder 112 determines whether cumulative addition of all feature values corresponding to teacher data of all types of comparison targets classified in the teacher data group 910 is completed, that is, whether image recognition for all types of comparison targets is completed, in step S310.

When it is determined that cumulative addition of all feature values corresponding to teacher data of all types of comparison targets is not completed, that is, output of information on similarities with all comparison targets classified in the teacher data group 910 is not completed in step S310 (“NO” in step S310), the cumulative adder 112 returns to step S200. Then, the cumulative adder 112 repeats the process of steps S200 to S3100, that is, calculation and output of information on similarities with other comparison targets, which are not presently output, until output of information on similarities with all types of comparison targets is completed. Since the teacher data group 910 is composed of teacher data corresponding to each of four types of comparison targets, the cumulative adder 112 repeats the process of steps S200 to S310 four times.

When it is determined that output of information on similarities with all comparison targets classified in the teacher data group 910 is completed in step S310 (“YES” in step S310), the image recognition device 10 (SVM operator 110) finishes the SVM operation process for each piece of teacher data.

According to the aforementioned processing, first, the image recognition device 10 reads each piece of teacher data included in the teacher data group 910 stored in the data storage 90 once, calculates feature values corresponding to all pieces of teacher data, and temporarily stores the feature values in the feature value storage 120 in the SVM operation in the image recognition process. Then, the image recognition device 10 reads feature values corresponding to teacher data classified into the same comparison target type from the feature values stored in the feature value storage 120, cumulatively adds the read feature values, and outputs the cumulatively added feature values as information representing similarity with each comparison target type (result of the image recognition process). According, the image recognition device 10 can output the information representing similarity with each comparison target type calculated through the SVM operation as information on a recognition target recognized through the image recognition process without reading identical teacher data (duplicate teacher data) classified into a plurality of types of comparison targets multiple times whenever a similarity with each comparison target type is output as in the SVM operation in the conventional image recognition process.

Accordingly, the image recognition device 10 can reduce the number of times teacher data is read from the data storage 90 when the SVM operation process is performed, that is the number of times the data storage 90 is accessed in the image recognition device 10, to below the number of times teacher data is read when the SVM operation process is performed in the conventional image recognition process. Furthermore, since the feature value corresponding to each piece of teacher data is temporarily stored in the feature value storage 120, the image recognition device 10 performs the operation of calculating the feature value corresponding to each piece of read teacher data only once without performing the operation of calculating the same feature value from the same teacher data which has been redundantly read as in the SVM operation in the conventional image recognition process, and thus an operation load in the SVM operation process can also be reduced.

More specifically, in the SVM operation in the conventional image recognition process, 1500 pieces of teacher data are read from the data storage 90 for each of comparison targets classified into four types, that is, the number of times the data storage 90 is accessed is 4 types×1500=6000. In addition, in the SVM operation in the conventional image recognition process, the operation of calculating a feature value corresponding to each piece of teacher data is performed 6000 times. Whereas the image recognition device 10 repeats the process of steps S100 to S130 the same number of times as the number (5000) of pieces of teacher data included in the teacher data group 910, that is, the number of times the data storage 90 is accessed, is 5000. In addition, in the image recognition device 10, the operation of calculating a feature value corresponding to each piece of teacher data is performed 5000 times.

According to the first embodiment, an image recognition device (image recognition device 10) is provided which performs an image recognition process for an input image based on a teacher data group (teacher data group 910) including a plurality of pieces of teacher data corresponding to histograms of images of comparison targets to be recognized and classified into each comparison target type, the image recognition device (image recognition device 10) including an SVM operator (SVM operator 110) which performs a support vector machine (SVM) operation for a histogram (recognition object data 950), which has been generated based on visual words of an image, based on each piece of the plurality of pieces of teacher data included in the teacher data group 910, and a data storage (feature value storage 120) which temporarily stores data generated during the image recognition process, wherein the SVM operator 110 includes a feature value calculator (feature value calculator 111) which compared a histogram (recognition object data 950) of the input image with a histogram of a comparison target represented by teacher data and calculates a feature value representing a degree to which a recognition target captured in the input image is similar to the comparison target, and a cumulative adder (cumulative adder 112) which cumulatively adds feature values corresponding to teacher data classified into the same comparison target type, wherein the feature value calculator 111 calculates feature values corresponding to all teacher data included in the teacher data group 910 for each piece of teacher data and stores all the calculated feature values in the feature value storage 120 in the SVM cooperation process, and the cumulative adder 112 reads feature values corresponding to teacher data classified into the same comparison target type from all the stores feature values, cumulatively adds the feature values and outputs the cumulatively added feature values as a recognition result of the recognition target in the image recognition process after the feature value calculator 111 stores all the feature values in the feature value storage 120.

In addition, according to the first embodiment, in the image recognition device 10, the feature value calculator 111 calculates all feature values corresponding to all teacher data included in the teacher data group 910 and stores the calculated feature values in the feature value storage 120 when the number of pieces of teacher data included in the teacher data group 910 is less than the number of times the cumulative adder 112 reads and cumulatively adds the feature values stored in the feature value storage 120 until all recognition results of the recognition target in the image recognition process are output.

In addition, according to the first embodiment, an image recognition method is provided in an image recognition device (image recognition device 10) which performs an image recognition process for an input image based on a teacher data group (teacher data group 910) including a plurality of pieces of teacher data corresponding to histograms of images of comparison targets to be recognized and classified into each comparison target type, the image recognition method including an SVM operation step of performing a support vector machine (SVM) operation for a histogram (recognition object data 950), which has been generated based on visual words of an image, based on each piece of the plurality of pieces of teacher data included in the teacher data group 910, wherein the SVM operation step includes a feature value calculation step of comparing a histogram (recognition object data of the input image with a histogram of a companion target represented by teacher data and calculating a feature value representing a degree to which a recognition target captured in the input image is similar to the comparison target, and a cumulative addition step of cumulatively adding feature values corresponding to teacher data classified into the same comparison target type, wherein feature values corresponding to all teacher data included in the teacher data group 910 are calculated for each piece of teacher data and all the calculated feature values are stored in a data storage (feature value storage 120) which temporarily stores data generated during the image recognition process in the feature value calculation step and, after all the feature values are stored in the feature value storage 120 in the feature value calculation step, feature values corresponding to teacher data classified into the same comparison target type are read from all the stored feature values and cumulatively added, and the cumulatively added feature values are output as a recognition result of the recognition target in the image recognition process in the cumulative addition step.

As described above, the image recognition device 10 of the first embodiment includes the feature value storage 120 for storing feature values corresponding to all teacher data included in the teacher data group 910 stored in the data storage 90. In addition, the image recognition device 10 of the first embodiment temporarily stores, in the feature value storage 120, feature values corresponding to all teacher data and calculated by reading each piece of teacher data included in the teacher data group 910 once in the SVM operation to the image recognition process. Thereafter, the image recognition device 10 of the first embodiment reads feature values corresponding to teacher data classified into the same comparison target type from the feature values stored in the feature value storage 120, cumulatively adds the read feature values, and outputs the cumulatively added feature values as information representing a similarity for each comparison target type calculated through the SVM operation (result of the image recognition process). That is, the image recognition device 10 of the first embodiment output information representing a similarity for each comparison target type simply by reading each piece of teacher data included in the teacher data group 910 stored in the data storage 90 once.

Accordingly, the image recognition device 10 of the first embodiment can output information representing a similarity for each comparison target type as information on a recognition target recognized through the image recognition process (result of the image recognition process) without repeating reading of the same teacher data and calculation of the same feature value multiple times as in the conventional image recognition device performing the image recognition process. That is, in the image recognition device 10 of the first embodiment the number of times teacher data is read from the data storage 90 (the number of times the data storage 90 is accessed) when the SVM operation process is performed and the number of operations of calculating a feature value corresponding to each piece of teacher data can be reduced to below those in the conventional image recognition device performing the image recognition process. Accordingly, in the image recognition device 10 of the first embodiment, a load in the image recognition process can be reduced to below that in the conventional image recognition device performing the image recognition process. The fact that the load in the image recognition process in the image recognition device 10 of the first embodiment can be reduced may lead to increase in the efficiency and processing speed of the image recognition process in the image recognition system 1 including the image recognition device 10.

In the image recognition device 10 of the first embodiment, the configuration in which the feature value calculator 111 included in the SVM operator 110 reads the recognition object data 950 and each piece of teacher data included in the teacher data group 910 from the data storage 90 has been described. However, the configuration and method for reading the recognition object data 950 and teacher data from the data storage 90 are not limited to the configuration and method illustrated in the first embodiment. For example, a configuration in which the image recognition device 10 includes a direct memory access (DMA) unit which performs data transfer with the data storage 90 through DMA and the DMA unit transmits the recognition object data 950 and each piece of teacher data acquired from the data storage 90 through DMA to the feature value calculator 111 in accordance with instructions from the feature value calculator 111 may be conceived.

In addition, in the image recognition device 10 of the first embodiment, an exemplary case in which the image recognition process is performed using the teacher data group 910 composed of 5000 pieces of teacher data including 1500 histograms for each of comparison targets classified into four types has been described. Furthermore, in the image recognition device 10 of the first embodiment, the effect of reducing the number of times teacher data is read and the number of operations of calculating feature values by performing reading of teacher data, which is performed 6000 times in the conventional image recognition process, by the same number as the number of pieces of teacher data included in the teacher group 910 has been described. However, the number of types of comparison targets classified in the teacher data group 910 and the number of pieces of teacher data constituting the teacher data group 910 are not limited to the numbers in the first embodiment. Accordingly, it is conceivable that the number of times teacher data is read in the image recognition device 10 of the first embodiment may become equal to or greater than that in the conventional image recognition device performing the image recognition process depending on the number of types of comparison targets recognized in the image recognized device 10 and the configuration of the teacher data group 910.

For example, when the image recognition device 10 recognized only three types of comparison targets even though the teacher data group 910 has the configuration described in the first embodiment, the number of times teacher data is read by the conventional image recognition device performing the image recognition process is 4500 whereas the number of times teacher data is read by the image recognition device 10 of the first embodiment is 5000. In addition, when all histograms included in the teacher data group 910 are exclusive for each comparison target type, for example, the number of times teacher data is ready by the conventional image recognition device performing the image recognition process is the same as the number of times teacher data is read by the image recognition device 10 of the first embodiment. Accordingly, the image recognition device 10 of the first embodiment may also perform the same operation as the conventional image recognition device performing the image recognition process depending on the number of types of comparison targets to be recognized or the configuration of the teacher data group 910. That is, the operation of the image recognition device 10 of the first embodiment may be changed to the operation described using the flowchart of FIG. 3 or the same operation as the conventional image recognition device depending on the number of types of comparison targets to be recognized or the configuration of the teacher data group 910.

More specifically, in the image recognition device 10 of the first embodiment, the number obtained by multiplying the number of types of comparison targets to be recognized by the number of histograms corresponding to each comparison target, that is, the total number of histograms corresponding to respective comparison targets, is compared with the number of pieces of teacher data constituting the teacher data group 910. The total number of histograms corresponding to respective comparison targets to be recognized is the number of times teacher data is read in the conventional image recognition device performing the image recognition process. In addition, when the number of times teacher data is read in the conventional image recognition device performing the image recognition process is equal to or less than the number of pieces of teacher data constituting the teacher data group 910, the same operation as the conventional image recognition device is performed. On the other hand, when the number of times teacher data is read in the conventional image recognition device performing the image recognition process is greater than the number of pieces of teacher data constituting the teacher data group 910, the operation of the image recognition device 10 of the first embodiment described using the flowchart of FIG. 3 is performed.

Further, the number of times teacher data is read in the conventional image recognition device performing the image recognition process corresponds to the number of times the cumulative adder 112 reads and cumulatively adds feature values stored in the feature value storage 120 until output of information on similarities with all types of comparison targets to be recognized is completed, that is, until the SVM operation process in the image recognition process is completed. Accordingly, a configuration in which the operation of the image recognition device 10 of the first embodiment is changed based on the number of times the cumulative adder 112 reads and cumulatively adds feature values may be conceived. That is, the operation of the image recognition device 10 of the first embodiment may be changed such that the same operation as the conventional image recognition device is performed when the number of pieces of teacher data constituting the teacher data group 910 is equal to or greater than the number of times the cumulative adder 112 reads and cumulatively adds feature values, and the operation of the image recognition device 10 of the first embodiment described using the flowchart of FIG. 3 is performed when the number of pieces of teacher data constituting the teacher data group 910 is less than the number of times the cumulative adder 112 reads and cumulatively adds feature values.

Further, in the image recognition device 10 of the first embodiment, a case in which the teacher data group 910 including each of histograms of a large amount of images classified into each type of comparison targets to be recognized is stored in the data storage 90 has been described. However, the format of the teacher data group 910 stored in the data storage 90 is not limited to the format illustrated in the first embodiment. For example, a case in which histograms (teacher data) of a large amount of images classified into each type of comparison targets to be recognized are integrated as one piece of data and then reversibly compressed and stored in the data storage 90 may be conceived.

### Second Embodiment

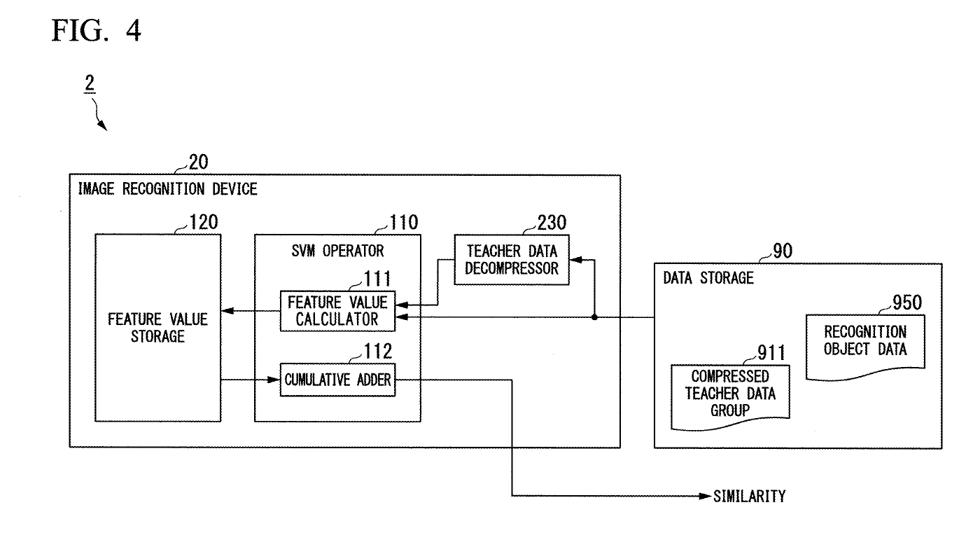

Next a second embodiment of the present invention will be described. FIG. 4 is a block diagram illustrating a schematic configuration of an image recognition device in the second embodiment of the present invention. In FIG. 4, the image recognition device 20 includes the SVM operator 110, the feature value storage 120 and a teacher data decompressor 230. In addition, she SVM operator 110 includes the feature value calculator 111 and the cumulative adder 112. FIG. 4 also illustrates the data storage 90 which stores data used when the image recognition device 20 performs the image recognition process and shows an image recognition system 2 including the image recognition device 20.

The image recognition device 20 illustrated in FIG. 4 further includes the teacher data decompressor 230 in addition to the image recognition device 10 of the first embodiment illustrated in FIG. 1. In addition, other components included in the image recognition device 20 are the same as the components included in the image recognition device 10 of the first embodiment illustrated in FIG. 1. Accordingly, in the following description, the same components of the image recognition device as those included in the image recognition device 10 of the first embodiment are referred to by the same signs and detailed description of each component is omitted, and only components and operations of the image recognition device which are different from the image recognition device 10 of the first embodiment are described.

Like the image recognition device 10 of the first embodiment, the image recognition device 20 performs the image recognition process for an input image and outputs information on a similarity with each piece of teacher data as information representing a degree to which a recognition target recognized through the image recognition process is similar to a comparison target (result of the image recognition process). However, the image recognition device 20 has a configuration in which the SVM operation process is performed based on teacher data integrated as one piece of data and reversibly compressed (referred to as a “compressed teacher data group 911” hereinafter). Further, the image recognition device 20 also performs the visual word operation process, the histogram operation process and the like, like the image recognition device 10 of the first embodiment. The following description is also based on the assumption that the visual word operation and the histogram operation process for an input image are completed.

The data storage 90 stores the compressed teaches data group 911 used when the image recognition device 20 performs the image recognition process and the recognition object data 950 of objects for which the image recognition device 20 performs the image recognition process.

The compresses teacher data group 911 has a configuration in which teacher data which is the same as the teacher data group 910 stored in the data storage 90 in the image recognition system 1 including the image recognition device 10 of the first embodiment illustrated in FIG. has been integrated as one piece of data and reversibly compressed. For example, when the compassed teacher data group 911 includes teacher data of comparison targets of four types of person, dog, cat and flower, all of 5000 pieces of teacher data (in which 1000 histograms are duplicate) representing 1500 histograms corresponding to each comparison target (a total of 6000 histograms) are integrated and reversibly compressed to be configured as one piece of data (teacher data group).

The image recognition device 20 performs the image recognition process for the recognition object data 950 stored in the data storage 90 based on each piece of teacher data included in the compressed teacher data group 911 stored in the data storage 90 and outputs information on a similarity with each piece of teacher data (result of the image recognition process) for each piece of teacher data.

The teacher data decompressor 230 decompresses the compressed teacher data group 911 used when the image recognition device 20 performs the image recognition process. Accordingly, each piece of teacher data included in the compressed teacher data group 911 is restored so the same format as each piece of teacher data included the teacher data group 910 used when the image recognition device 10 of the first embodiment performs the image recognition process. In addition, the teacher data decompressor outputs each piece of teacher data which has been decompressed to the SVM operator 110.

The SVM operator 110 performs the SVM operation of comparing histograms of an entire image represented by the recognition object data 950 with histograms of a comparison target represented by each piece of teacher data output from she teacher data decompressor 230 to calculate a similarity for each comparison target type classified in the compressed teacher data group 911 in the image recognition process. In addition, the SVM operator 110 outputs information representing each calculated similarity as information on a recognition target recognized through the image recognition process performed by the image recognition device 20.

In this manner, the image recognition device 20 includes the teacher data decompressor 230 which decompresses one compressed teacher data group 911 which has been reversibly compressed. In addition, in the image recognition device 20, the teacher data decompressor 230 decompresses each piece of teacher data included in the compressed teacher data group 911 before the SVM operation in the image recognition process. Further, the image recognition device 20 includes the feature value storage 120 which stores a feature value corresponding to each piece of teacher data like the image recognition device 10 of the first embodiment. In addition, the image recognition device 20 calculates feature values corresponding to all teacher data decompressed (restored) by the teacher data decompressor and temporarily stores the feature values in the feature value storage 120 like the image recognition device 10 of the first embodiment. Then, the image recognition device 20 reads feature values corresponding to teacher data classified into the same comparison target type from the feature values stored in the feature value storage 120, cumulatively adds the read feature values and outputs the cumulatively added feature values as information representing a similarity for each comparison target type (result of the image recognition process) like the image recognition device 10 of the first embodiment.

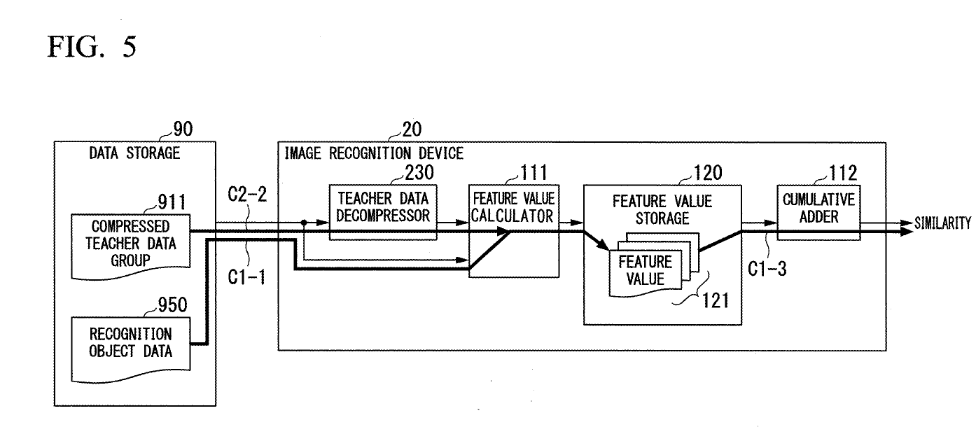

Data flow when the image recognition device 20 performs the image recognition process will be described. FIG. 5 is a diagram illustrating data flow when the image recognition process is performed in the image recognition device 20 of the second embodiment of the present invention. FIG. 5 shows data flow of the SVM operation process in the image recognition process performed by the image recognition device 20 similarly to the data flow in the image recognition device 10 of the first embodiment shown in FIG. 2. Accordingly, the data flow shown in FIG. 5 is data flow when the image recognition device 20 performs the SVM operation process after completion of the visual word operation process and histogram operation process for an image input to the image recognition device 20. The data flow to the image recognition device 20 illustrated in FIG. 5 includes the same data flow as the data flow in the image recognition device 10 of the first embodiment illustrated in FIG. 2.

In the SVM operation process in the image recognition device 20, the feature value calculator 111 included in the SVM operator 110 reads the recognition object data 950 from the data storage 90 (path C1-1) as in the data flow in the image recognition device 10 of the first embodiment. Thereafter, the teacher data decompressor 230 reads the comprised teacher data group 911 from the data storage 90, decompresses the read compressed teacher data group 911 and sequentially outputs all of the decompressed teacher data to the feature value calculator 111 in the SVM operator 110 (path C2-2). Further, the feature value calculator 111 calculates feature values based on the read recognition object data 950 and the teacher data output from the teacher data decompressor 230 and temporarily stores the calculated feature values in the feature value storage 120. FIG. 5 illustrates a state in which the feature values 121 calculated by the feature value calculator 111 have been stored in the feature value storage 120.

Subsequently, in the SVM operation process in the image recognition device 20, the cumulative adder 112 included in the SVM operator 110 reads a feature value 121 corresponding to teacher data classified into the same comparison target type from the feature values 121 stored in the feature value storage 120 by the feature value calculator 111 and cumulatively adds the read feature value as in the data flow in the image recognition device 10 of the first embodiment. In addition, the cumulative adder 112 outputs the cumulatively added feature value as information representing a similarity with a comparison target of the type represented by the read feature value 121 (result of the image recognition process) (path C1-3).

The processing procedure of the SVM operation process in the image recognition process performed by the image recognition device 20 differs from the processing procedure of the SVM operation process in the image recognition process performed by the image recognition device 10 of the first embodiment illustrated in FIG. 3 in terms of only teacher data.

More specifically, the teacher data decompressor 230 reads the compressed teacher data group 911 from the data storage 90 and decompresses the compressed teacher data group 911 before the image recognition device 20 initiates the processing procedure of the SVM operation process illustrated in FIG. 3. Then, the feature value calculator 111 acquires one piece of teacher data (first teacher data) output from the teacher data decompressor 230 in step S100 illustrated in FIG. 3 and repeat the process of steps S110 to S130 until storage of all feature values corresponding to teacher data output from the teacher data decompressor 230 in the feature value storage is completed. That is, the feature value calculator 111 repeats the process of steps S100 to S130, illustrated in FIG. 3, 5000 times until storage of all feature values corresponding to 5000 pieces of teacher data included in the compressed teacher data group 911 in the feature value storage 120 is completed.

Subsequently, the cumulative adder 112 repeats the process steps to S220 illustrated in FIG. 3 until cumulative addition of all feature values is completed and further repeats the process of steps S200 to S310 until output of information on similarities with all types of comparison targets classified in the compressed teacher data group 911 (result of the image recognition process) is completed. That is, the image recognition device 20, the cumulative adder 112 repeats the process of steps S200 to S220, illustrated in FIG. 3, 1500 times and repeats the process of steps S200 to S310 four times.

Accordingly, the image recognition device 20 can output information representing a similarity for each comparison target type, which is calculated through SVM operation, as information on a recognition target recognized through the image recognition process (result of the image recognition process) like the image recognition device 10 of the first embodiment.

According to the second embodiment, an image recognition device (image recognition device 20) is provided further including a teacher data decompressor (teacher data decompressor 230) which decompresses a teacher data group (compresses teacher data group 911) input in a format in which all teacher data has been integrated into one piece of data and reversibly compressed to restore the teacher data group to respective pieces of teacher data, wherein the teacher data decompressor 230 decompresses the compressed teacher data group 911 to restore the compressed teacher data group 911 to respective pieces of teacher data, and a feature value calculator (feature value calculator 111) calculates all feature values corresponding to the teacher data restored by the teacher data decompressor 230 and stores the feature values in a data storage (feature value storage 120) in the SVM operation process.

As described above, the image recognition device 20 of the second embodiment includes the teacher data decompressor 230 which decompresses one reversibly compressed teacher data group 911. In addition, the image recognition device 20 of the second embodiment includes the feature value storage 120 for storing feature values corresponding to all teacher data included in the compressed teacher data group 911 and decompressed by the teacher data decompressor 230, like the image recognition device 10 the first embodiment. Further, the image recognition device 20 of the second embodiment temporarily stores all feature values calculated using all teacher data decompressed by the teacher data decompressed 230 in the feature value storage 120, and then reads a feature value corresponding to teacher data classified into the same comparison target type from the feature values stored in the feature value storage 120, cumulatively adds the read feature value and outputs the cumulatively added feature value as information representing a similarity for each comparison target type (result of the image recognition process) in the SVM operation in the image recognition process. That is, in the image recognition device 20 of the second embodiment, information representing a similarity for each comparison target type classified in the compressed teacher data group 911 is output simply by reading the compressed teacher data group 911 stored in the data storage 90 once. Accordingly, the image recognition device 20 of the second embodiment can reduce a load in the image recognition process to below that in the conventional image recognition device performing the image recognition process, like the image recognition device 10 of the first embodiment.

More specifically, when the image recognition process is performed based on the compressed teacher data group 911 which has bee a reversibly compressed, the conventional image recognition device performing the image recognition process initially reads and decompresses the compressed teacher data group 911 and outputs a similarity for a comparison target of the first type (result of the image recognition process) using teacher data (e.g., 1500 pieces of teaches data) classified into comparison targets of the first type from among all of the decompressed teacher data (e.g., 5000 pieces of teacher data). Then, the conventional image recognition device performing the image recognition process discards all of the previously decompressed teacher data, reads and decompresses the compressed teacher data group 911 again, and outputs a similarity for a comparison target of the second type (result of the image recognition process) using teacher data (e.g., 1500 pieces of teacher data) classified into comparison targets of the second type from among all the decompressed teacher data (e.g., 5000 pieces of teacher data). In this manner, the conventional image recognition device performing the image recognition process performs reading and decompression of the compressed teacher data group 911 for each comparison target for which the image recognition process will be performed and discards each piece of decompressed teacher data each time. That is, in the conventional image recognition device performing the image recognition process, reading and decompression of the same compressed teacher data group 911 and the operation of calculating feature values corresponding to the same teacher data (duplicate teacher data) are performed multiple times.

On the other hand, the image recognition device 20 of the second embodiment reads and decompresses the compressed teacher data group 911 stored in the data storage 90 only once, calculates feature values (e.g., 5000 feature values) corresponding to all decompressed teacher data, and temporarily stores the feature values in the feature value storage 120. Then, the image recognition device 20 of the second embodiment reads feature vales (e.g., 1500 feature values) corresponding to teacher data classified into the same comparison target type from the feature values stored in the feature value storage 120, cumulatively adds the read feature values, and outputs the cumulatively added feature values as information representing a similarity for each comparison target type (result of the image recognition process). That is, in the image recognition device 20 of the second embodiment, reading and decompression of the compressed teacher data group 911 and the operation of calculating feature values corresponding to the same teacher data (duplicate teacher data) and performed only once. That is, in the image recognition device 20 of the second embodiment, it is possible to output information representing a similarity for each comparison target type as information on a recognition target recognized through the image recognition process without repeating reading of the same teacher data and calculation of the same feature values multiple times as in the conventional image recognition device performing the image recognition process.

In this manner, in the image recognition device 20 of the second embodiment, the number of times of reading the reversibly compressed teacher data group 911 from the data storage 90 when the SVM operation process is performed (the number of times of accessing the data storage 90), the number of operations of decompressing the reversibly compressed teacher data group 911 and the number of operations of calculating a feature value corresponding to each piece of decompressed teacher data can be reduced to below those in the conventional image recognition device performing the image recognition process. Accordingly, in the image recognition device 20 of the second embodiment, a load in the image recognition process can also be reduced to below that in the conventional image recognition device performing the image recognition process, as in the image recognition device 10 of the first embodiment. The fact that the load in the image recognition process in the image recognition device 20 of the second embodiment can be reduced may also lead to increases in the efficiency and processing speed of the image recognition process in the image recognition system 2 including the image recognition device 20, as ion the image recognition device 10 of the first embodiment.

Further, the image recognition device of the second embodiment may have a configuration in which the DMA unit included in the image recognition device 20 transmits the compressed teacher data group 911 acquired from the data storage 90 through DMA to the teacher data decompressor 230 at the request of the teaches data decompressor 230 similarly to the image recognition device 10 of the first embodiment.

In addition, the image recognition device 20 of the second embodiment may have a configuration in which the operation of the image recognition device 20 of the second embodiment is changed to the aforementioned operation or the same operation as the conventional image recognition device depending on the number of types of comparison targets to be recognized or the configuration of teacher data included in the compressed teacher data group 911 similarly to the image recognition device 10 of the first embodiment.

In the image recognition device 10 of the first embodiment and the image recognition device 20 of the second embodiment, description is based on the assumption that the visual word operation process and the histogram operation process for an input image is completed. However, in the image recognition device 10 of the first embodiment and the image recognition device 20 of the second embodiment, the visual word operation process and the histogram operation process for an input image are performed as in the conventional image recognition device performing the image recognition process, as described above. Furthermore, an image recognition device includes an SRAM or the like, for example, as a storage (memory) for temporarily storing data used as the visual word operation process and the histogram operation process, in general.

### Third Embodiment

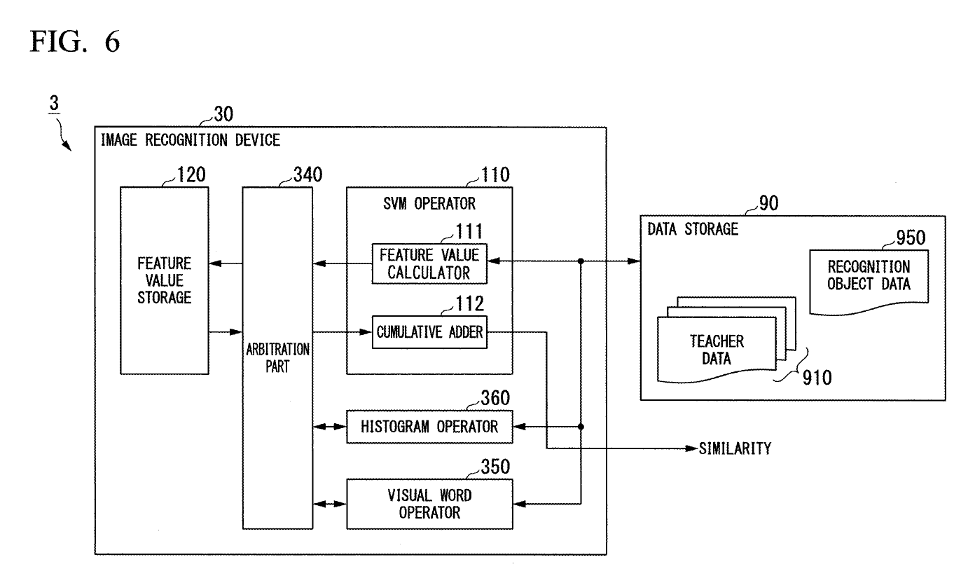

Next, a third embodiment of the present invention will be described. FIG. 6 is a block diagram illustrating a schematic configuration of an image recognition device in the third embodiment of the present invention. In FIG. 6, the image recognition device 30 includes the SVM operator 110, the feature value storage 120, an arbitration part 340, a visual word operator 350 and a histogram operator 360. In addition, the SVM operator 110 includes the feature value calculator 111 and the cumulative adder 112, FIG. 6 also illustrates the data storage 90 which stores data used when the image recognition device 30 performs the image recognition process and shows an image recognition system 3 including the image recognition device 30.

The image recognition device 30 illustrated in FIG. 6 shows the visual word operator 350 and the histogram operator 360 included in the image recognition device 10 of the first embodiment illustrated in FIG. 1 and further includes the arbitration part 340. Other components included in the image recognition device 30 are the same as the components included in the image recognition device 10 of the first embodiment illustrated in FIG. 1. Accordingly, in the following description, the same components of the image recognition device 30 as those in the image recognition device 10 of the first embodiment are referred to by the same signs and detailed description of each component is omitted, and only components and operations of the image recognition device 30, which differ from the image recognition device 10 of the first embodiment, are described.

Like the image recognition device 10 of the first embodiment, the image recognition device 30 also performs the image recognition process for an input image and outputs information on a similarity with each piece of teacher data as information representing a degree to which a recognition target recognized through the image recognition process is similar to a comparison target (result of the image recognition process). However, the image recognition device 30 has a configuration in which the feature value storage 120 is shared by the SVM operator 110, the visual word operator 350 and the histogram operator 360.

The visual word operator 350 performs a visual word operation process for generating visual words for an image photographed, for example, by a photographing system equipped with the image recognition system 3. More specifically, the visual word operator 350 performs an operation of generating a set of representative local patterns (visual words) in an image input to the image recognition device 30. The visual word operator 350 uses the feature value storage 120 as a storage (memory) which temporarily stores data and the like during operation when the operation of generating each visual word in the input image is performed. In addition, the visual word operator 350 outputs data of a set of finally generated visual words to the data storage 90 and stores the data therein. The method of the visual word operation process in the visual word operator 350 is the same as the method of the visual word operation process to the conventional image recognition technology and thus detailed description thereof is omitted.

The histogram operator 360 performs a histogram operation process for generating histograms of an entire image photographed, for example, by a photographing system equipped with the image recognition system 3 based on visual words. More specifically, the histogram operator 360 reads each piece of visual word data generated and stored by the visual word operator 350 from the data storage 90 and performs an operation of generating histograms of an entire input image based on the read visual word data. The histogram operator 360 uses the feature value storage 120 as a storage (memory) which temporarily stores data and the like during operation when the operation of generating histograms of the entire input image is performed. In addition, the histogram operator 360 outputs finally generated histogram data to the data storage 90 and stores the data therein. The method of the histogram operation process in the histogram operator 360 is the same as the method of the histogram operation process in the conventional image recognition technology and thus detailed description thereof is omitted.

In the image recognition device 30, histogram data finally generated by the histogram operator 360 is the recognition object data 950. FIG. 6 illustrates a state in which the teacher data group 910 and the recognition object data generated by the histogram operator 360 have been stored in the data storage 90.

The arbitration part 340 arbitrates use of the feature value storage 120 by components included in the image recognition device 30, that is, the visual word operator 350, the histogram operator 360 and the SVM operator 110 when the image recognition device 30 executes the image recognition process. The processes of the visual word operator 350, the histogram operator 360 and the SVM operator 110 are exclusively performed in the image recognition device 30. More specifically, in the image recognition device 30, the visual word operator 350 initially generates data of a set of visual words in an input image. Subsequently, the histogram operator generates histograms of the entire input image. Finally, the SVM operator 110 calculates a similarity for each comparison target type classified in the teacher data group 910 and outputs the similarity as information on a recognition target recognized through the image recognition process performed by the image recognition device 30 (result of the image recognition process).

Accordingly, the arbitration part 340 exclusively allocates components which use the feature value storage 120 in respective operation processing steps when the image recognition device 30 executes the image recognition process. More specifically, the arbitration part 340 allocates the visual word operator 350 as a component using the feature value storage 120 in the visual word operation processing step in which the visual word operator 350 generates each visual word in the input image. Subsequently, the arbitration part 340 allocates the histogram operator 360 as a component using the feature value storage 120 in the histogram operation processing in which the histogram operator 360 generates histograms (recognition object data 950) of the entire input image. Finally, the arbitration part 340 allocates the SVM operator 110 as a component using the feature value storage 120 in the SVM operation processing step in which the SVM operator 110 outputs information representing a similarity for each comparison target type classified in the teacher data group 910.

In addition, the arbitration part 340 performs access to the feature value storage 120 according to control of writing data to the feature value storage 120 and control of reading data from the feature value storage 120, which are output from each component allocated as a component using the feature value storage 120.

The feature value storage 120 stores data to be temporally stored by a component in the image recognition device 30, which is allocated as a using component by the arbitration part 340. A storage capacity in which the feature value storage 120 can store data is a storage capacity which can save a maximum amount of data to be stored in the feature value storage 120 when a component in the image recognition device 30, which is allocated as a using component by the arbitration part 340, executes each process. That is, the storage capacity of the feature value storage 120 is the same as maximum storage capacity necessary for a component which stores a largest amount of data in the feature value storage 120, among the visual word operator 350, the histogram operator 360 and the SVM operator 110, to execute the process.

In image recognition devices, a largest amount of data and the like during operation is temporarily stored in the visual word operation process, in general. Accordingly, the storage capacity of the feature value storage 120 corresponds to a storage capacity which can save an amount of data necessary for the visual word operator 350 to perform the process of generating data of a set of visual words.

In this manner, the image recognition device 30 includes the arbitration part 340 which arbitrates use of the feature value storage 120, and the SVM operator 110, the visual word operator 350 and the histogram operator 360 shares the feature value storage 120. Accordingly, the image recognition device 30 can employ a configuration in which a feature value for each piece of teacher data, calculated by the feature value calculator 111, is stored in the feature value storage 120 without including a dedicated storage (memory) such as an SRAM as the feature value storage 120 in order to reduce the number of times of reading teacher data from the data storage 90 (the number of times of accessing the data storage 90) when the SVM operation process in the image recognition process is performed.

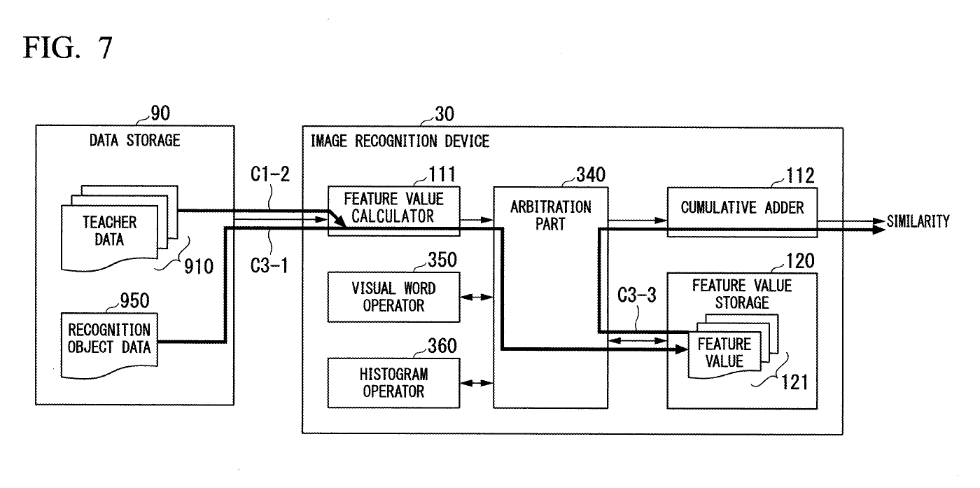

Data flow when the image recognition device 30 performs the image recognition process is described. FIG. 7 is a diagram illustrating data flow when the image recognition process is performed in the image recognition device 30 of the third embodiment of the present invention. FIG. 7 shows data flow of the SVM operation process in the image recognition process performed by the image recognition device 30 similarly to the data flow in the image recognition device 10 of the first embodiment shown in FIG. 2. Accordingly, the data flow shown in FIG. 7 is data flow when the image recognition device 30 performs the SVM operation process after completion of the visual word operation process executed by the visual word operator 350 and the histogram operation process executed by the histogram operator 360 based on visual words for an image input to the image recognition device 30. Further, the data flow in the image recognition device 30 illustrated in FIG. 7 includes the same data flow as the data flow in the image recognition device 10 of the first embodiment illustrated in FIG. 2.

In the SVM operation process in the image recognition device 30, the feature value calculator 111 included in the SVM operator 110 reads the recognition object data 950 from the data storage 90 (path C3-1). Further, the feature value calculator 111 sequentially reads all teacher data included in the teacher data group 910 from the data storage 90 (path C1-2). Then, the feature value calculator 111 calculates feature values based on each of the read recognition object data 950 and teacher data, outputs each of the calculated feature values to the feature value storage 120 via the arbitration part 340 and temporarily stores the feature values in the feature storage 120. FIG. 7 illustrates a state in which each feature value 121 calculated by the feature value calculator 111 has been stored in the feature value storage 120.

Subsequently, in the SVM operation process in the image recognition device 30, the cumulative adder 112 included in the SVM operator 110 reads feature values 121 corresponding to teacher data classified into the same comparison target type from the feature values 121 stored in the feature value storage 120 by the feature value calculator 111 via the arbitration part 340. In addition, the cumulative adder 112 cumulatively adds each of the read feature values 121 and outputs the cumulatively added feature value as information representing a similarity with a comparison target of the type represented by the read feature value 121 (result of the image recognition process) (path C3-3).

The processing procedure of the SVM operation in the image recognition process performed by the image recognition device 30 is the same as the processing procedure of the SVM operation process in the image process performed by the image recognition device 10 of the first embodiment illustrated in FIG. 3 except that data of each feature value is transferred through the arbitration part 340 when feature values are stored in the feature value storage 120 and feature values are read from the feature value storage 120.

More specifically; after the image recognition device 30 initiates the processing procedure of the SVM operation process illustrated in FIG. 3, the feature value calculator 111 outputs a feature value corresponding to each piece of teacher data to the feature value storage 120 via the arbitration part 340 and stores the feature data in the feature value storage 120 in step S120 illustrated in FIG. 3. In addition, the cumulative adder 112 reads each feature value corresponding to teacher data classified into the same comparison target type and stored in the feature value storage 120 via the arbitration part 340 in step S200 illustrated in FIG. 3. The processing procedure of the SVM operation process performed by the image recognition device 30 is the same as the processing procedure of the SVM operation process performed by the image recognition device 10 of the first embodiment except that paths through which each feature value is transmitted in steps S100 and S200 are different. That is, the SVM operation process in the image recognition device 30 is the same as that in the image recognition device 10 of the first embodiment.

Accordingly, the image recognition device 30 can also output information representing a similarity for each comparison target type, calculated through the SVM operation, as information on a recognition target recognized through the image recognition process (result of the image recognition process), like the image recognition device 10 of the first embodiment.

According to the third embodiment, an image recognition device (image recognition device 30) is provided further including an arbitration part (arbitration part 340) which arbitrates use of a data storage (feature value storage by a visual word operator (visual word operator 350), a histogram operator (histogram operator 360) and an SVM operator (SVM operator 110) which perform exclusive operation processes in an image recognition process, wherein the arbitration part 340 accesses the feature value storage 120 in response to access to the feature value storage 120 by any one operator (visual word operator 350, the histogram operator 360 or the SVM operator 110) to which use of the feature value storage 120 is allocated.

In addition, according to the third embodiment, in the image recognition device 30, the feature value storage 120 has a storage capacity which can save a maximum amount of data to be temporarily stored in the feature value storage 120 when the visual word operator 350 the histogram operator 360 and the SVM operator 110 execute the processes thereof.

As described above, the image recognition device 30 of the third embodiment includes the feature value storage 120 for storing feature values corresponding to all teacher data included in the teacher data group 910 in the SVM operation, like the image recognition device 10 of the first embodiment. In addition, the image recognition device 30 of the third embodiment temporarily stores feature values corresponding to all teacher data included in the teacher data group 910 in the feature value storage 120, and then reads and cumulatively adds feature values corresponding to teacher data classified into the same comparison target type and outputs information representing a similarly for each comparison target type (result of the image recognition process) in the SVM operation in the image recognition process, like the image recognition device 10 of the first embodiment. Accordingly, in the image recognition device 30 of the third embodiment, a load in the image recognition process can be reduced to below that in the conventional image recognition device performing the image recognition process as in the image recognition device 10 of the first embodiment. Further, the fact that the load in the image recognition process can be reduced in the image recognition device 30 of the third embodiment may lead to increases in the efficiency and processing speed of the image recognition process in the image recognition system 3 including the image recognition device 30 as in the image recognition device 10 of the first embodiment.

In addition, the image recognition device 30 of the third embodiment includes the arbitration part 340, and the feature value storage 120 is shared by components (the visual word operator 350, the histogram operator 360 and the SVM operator 110) in the image recognition device 30. Accordingly in the image recognition device 30 of the third embodiment, a storage (memory) used by component other than the SVM operator 110 can be used as the feature value storage 120 for storing feature values corresponding to all teacher data included in the teacher data group 910 when the SVM operator 110 performs the SVM operation process. Accordingly, the image recognition device 30 of the third embodiment can obtain the same effect as the image recognition device 10 of the first embodiment without including the feature value storage 120 as a dedicated storage (memory) used by the SVM operator 110. The fact that the SVM operator 110 need not include the dedicated feature value storage 120 used thereby in the image recognition device 30 of the third embodiment leads to a result that increase in the circuit scale of the image recognition device 30 can be prevented.

Further, the image recognition device 30 of the third embodiment may include a DMA unit like the image recognition device 10 of the first embodiment. In addition, the image recognition device 30 of the third embodiment may have a configuration to which the operation thereof in changed depending on the number of types of comparison target to be recognized or the configuration of the teacher data group 910 like the image recognition device 10 of the first embodiment.

Although the configuration of the image recognition device 30 of the third embodiment, in which the arbitration part 340 is included in the image recognition device 10 of the first embodiment, has been described, a configuration in which the arbitration part 340 is included in the image recognition device 20 of the second embodiment may be employed. In this case, it is possible to obtain the aforementioned effect acquired by sharing the feature value storage 120 with other components in addition to the same effect as that of the image recognition device 20 of the second embodiment.

As described above, according to each embodiment of the present invention, an image recognition device includes a feature value storage for storing all feature values corresponding to all teacher data used in the SVM operation in the image recognition process. In addition, in each embodiment of the present invention, each piece of teacher data is accessed once to calculate all feature values corresponding to each piece of teacher data and the feature values are temporarily stored at the feature value storage in the SVM operation in the imager recognition process. Thereafter, feature values corresponding to teacher data classified into the same type of targets are read from feature values stored in the feature value storage, cumulatively added and output as information representing a similarity for each target type (result of the image recognition process) in each embodiment of the present invention. Accordingly, in each embodiment of the present invention, it is possible to reduce an operation load in the SVM operation process in the image recognition process without performing a duplicate process of accessing the same teaches data and calculating the same feature value as in the conventional image recognition device.

Further, in each embodiment of the present invention, the image recognition device includes a teacher data decompressor for decompressing a reversibly compressed teacher data group. In addition, in each embodiment of the present invention, the teacher data decompressor decompresses the reversibly compressed teacher data group before the SVM operation. Thereafter, all feature values corresponding to each piece of teacher data decompressed by the teacher data decompresses are temporarily stored in the feature value storage, and then feature values corresponding to teacher data classified into the same type of targets are cumulatively added and output as information representing a similarity for each target type (result of the image recognition process) in each embodiment of the present invention. Accordingly, in each embodiment of the present invention, an operation load in the SVM operation process in the image recognition device can be reduced to below that in the conventional image recognition device even when teacher data used in the SVM operation has been reversibly compressed, that is, irrespective of teacher data format.

Further, in each embodiment of the present invention, the image recognition device includes an arbitration part which arbitrates components which use the feature value storage. In addition, the feature value storage is shared by a plurality of components which exclusively perform processes in the image recognition device in each embodiment of the present invention. Accordingly, in each embodiment of the present invention, it is possible to reduce the operation load in the SVM operation process in the image recognition device to below that in the conventional image recognition device in a state in which increase in the circuit size of the image recognition device has been suppressed without including the feature value storage as a dedicated storage used in the SVM operation.

Accordingly, in each embodiment of the present invention, the image recognition process can be efficiently performed and image recognition processing speed can be improved in an image recognition system including the image recognition device.

An exemplary case in which the teacher data group 910 or the compressed teacher data group 911 includes 1500 histograms corresponding to each of four comparison target types and is composed of 5000 pieces of teacher data has been described in each embodiment of the present invention. However, the number of comparison target types represented by the teaches data group 910 or the compressed teacher data group 911 is not limited to the number described in each embodiment of the present invention. In addition, the number of pieces of teacher data included in the teacher data group 910 or the compressed teacher data group 911 is not limited to the number described in each embodiment of the present invention. For example, it is conceivable that the numbers of histograms corresponding to respective comparison targets represented by the teacher data group 910 or the compressed teacher data group 911 are different in such a manner that the number of histograms corresponding to a certain comparison target is 1500 and the number of histograms corresponding to another comparison target is 1200.

Even in this case, the same effects as those of the present invention can be obtained by applying the idea of the present invention to change operations depending on the number of types of comparison targets to be recognized or the configuration of teacher data. That is, the number of times of reading all teacher data in order to perform the image recognition process to which the idea of the present invention is applied compared with the number of times of reading teacher data corresponding to each comparison target type in order to perform the conventional image recognition process, and operations are changed such that the image recognition process having a smaller number of times of reading teacher data is performed. More specifically, the sum of the numbers of histograms corresponding to respective comparison targets to be recognized, that is, the number of times of reading teacher data in the conventional image recognition process compared with the number of times of reading all teaches data in the image recognition process to which the idea of the present invention is applied, and operations are changed such that the image recognition process having a smaller number of times of reading teacher data is performed. Accordingly, the same effects as those of the present invention can be obtained even when the number of comparison target types represented by the teacher data group 910 or the compressed teaches data group 911 and the number of pieces of teacher data included in the teacher data group 910 or the compressed teacher data group 911 are different from those in the example described in each embodiment of the present invention.

Although preferred embodiments of the present invention have been described above, the present invention is not limited to such embodiments and modified examples thereof. Additions, omissions, substitutions, and other modifications of components can be made without departing from the spirit or scope of the present invention.

Furthermore, the present invention is not limited by the foregoing description, and is only limited by the scope of the appended claims.

What is claimed is:

1. An image recognition device which performs an image recognition process on an input image, based on a teacher data group including a plurality of pieces of teacher data corresponding to histograms of images of comparison targets to be recognized and classified into each type of the comparison targets, the image recognition device comprising:
a SVM operator which performs an SVM operation on histograms generated based on visual words of the images, based on each of the plurality of pieces of teacher data included in the teacher data group; and
a data storage which temporarily stores data generated during the image recognition process,
wherein the SVM operator comprises:
a feature value calculator which compares histograms of the input images with the histograms of the comparison targets represented by the teacher data and calculates feature values representing degrees to which a recognition target that is a target captured to the input image is similar to the comparison targets, and
a cumulative adder which cumulatively adds the feature values corresponding to the teacher data classified into the same type of comparison targets, and
wherein, in the SVM operation process,
the feature value calculator calculates all feature values corresponding to all teacher data included in the teacher data group for each piece of teacher data and stores all of the calculated feature values in the data storage, and
the cumulative adder reads the feature values corresponding to the teacher data classified into the same type of comparison targets from all of the stored feature values, cumulatively adds the read feature values, and outputs the cumulatively added feature values as a recognition result of the recognition target in the image recognition process, after the feature value calculator stores all of the feature values in the data storage.

2. The image recognition device according to claim 1,
wherein the feature value calculates all feature values corresponding to all teaches data included in the teacher data group and stores the feature values in the data storage when the number of pieces of teacher data included in the teacher data group is less than the number of times the cumulative adder reads and cumulatively adds the feature values stored in the data storage until all recognition results of the recognition target are output in the image recognition process.

3. The image recognition device according to claim 2, further comprising:
a teacher data decompressor which decompresses the teacher data group input in a format in which all teacher data has been integrated into one piece of data and reversibly compressed to restore respective pieces of teacher data,
wherein, in the SVM operation process,
the teacher data decompressor decompresses the teacher data group to restore the respective pieces of teacher data, and
the feature value calculator calculates all feature values corresponding to respective pieces of teacher data restored by the teacher data decompressor and stores the feature values in the data storage.

4. The image recognition device according to claim 2, further comprising:
an arbitration part which arbitrates use of the data storage by a visual word operator which exclusively performs operation processes in the image recognition process, a histogram operator, and the SVM operator,
wherein the arbitration part accesses the data storage in response to access to the data storage by any one operator to which use of the data storage is allocated.

5. The image recognition device according to claim 3, further comprising:
an arbitration part which arbitrates use of the data storage by a visual word operator which exclusively performs operation processes in the image recognition process, a histogram operator, and the SVM operator,
wherein the arbitration part accesses the data storage in response to access to the data storage by any one operator to which use of the data storage is allocated.

6. The image recognition device according to claim 4, wherein the data storage has a storage capacity which serves a maximum amount of data to be temporarily stored in the data storage when the visual word operator, the histogram operator and the SVM operator execute processes thereof.

7. The image recognition device according to claim 5, wherein the data storage has a storage capacity which saves a maximum amount of data to be temporarily stored in the data storage when the visual word operator, the histogram operator and the SVM operator execute processes thereof.

8. An image recognition method in an image recognition device which performs an image recognition process on an input image based on a teacher data group including a plurality of pieces of teacher data corresponding to histograms of images of comparison targets to be recognized and classified into each type of the comparison targets, the image recognition method comprising:
a SVM operation step of performing an SVM operation on histograms generated based on visual words of the images, based on each of the plurality of pieces of teacher data included in the teacher data group,
wherein the SVM operation step comprises:
a feature value calculation step of comparing histograms of the input images with the histograms of the comparison targets represented by the teacher data and calculating feature values representing degrees to winch a recognition target that is a target captured in the input image is similar to the comparison targets; and
a cumulative addition step of cumulatively adding the feature values corresponding to the teacher data classified into the same type of comparison targets, and
wherein, in the feature calculation step, the feature vales corresponding to all teacher data included in the teacher data group are calculated for each piece of teacher data and all of the calculated feature values are stored in a data storage which temporarily stores data generated during the image recognition process, and
wherein, in the cumulative addition step, the feature values corresponding to the teacher data classified into the same type of comparison targets are read from all of the stored feature values and cumulatively added, and the cumulatively added feature values are output as a recognition result of the recognition target in the image recognition process, after all of the feature values are stored in the data storage in the feature value calculation step.
